(19) United States
(12) Patent Application Publication
(10) Pub. No.: US 2022/0269699 A1
(43) Pub. Date: Aug. 25, 2022

(54) SYSTEMS AND METHODS FOR PROVIDING DATA TRANSFER USER INTERFACES

(71) Applicant: The Toronto-Dominion Bank, Toronto (CA)

(72) Inventor: Christopher Mark JONES, Villanova, PA (US)

(73) Assignee: The Toronto-Dominion Bank, Toronto (CA)

(21) Appl. No.: 17/182,446

(22) Filed: Feb. 23, 2021

(51) Int. Cl. G06F 16/28; G06F 9/451

(52) U.S. Cl. CPC G06F 16/285; G06F 9/451

(57) ABSTRACT

Methods and computer systems for handling data transfers. Receiving, via a communications module, a request for a data transfer from a transferor to a recipient, the request including one or more parameters. Identifying a category of the data transfer based on at least one of the one or more parameters and stored categorization data. Processing the request for the data transfer based on the category by providing, to a computing device associated with the transferor, a category-specific user interface for processing the request for the data transfer.

### FIELD

The present disclosure relates to electronic data transfer systems and, more particularly, to systems and methods for providing user interfaces for electronic data transfers.

### BACKGROUND

Online bill payments are often performed using a graphical user interface. For example, a business may issue an invoice to a customer and the customer may then login to their financial institution's computer systems to pay the invoice via an online banking interface.

An online banking interface traditionally is a generic user interface that collects the same payment details for each payment. For example, the generic user interface may prompt a user to select a payee from a defined list of payees and further require the user to input the amount to be electronically debited from the user's bank account and the data on which the debit should occur. The financial institution's computer systems can then use this information to transfer the payment.

### BRIEF DESCRIPTION OF THE DRAWINGS

Reference will now be made, by way of example, to the accompanying drawings which show example embodiments of the present application, and in which:

FIG. 1 shows a schematic diagram illustrating an operating environment of an example embodiment according to the subject matter of the present application;

FIG. 2 shows a high-level schematic diagram of the remote device of FIG. 1;

FIG. 3 shows a simplified organization of software components stored in a memory of the remote device of FIG. 2;

FIG. 4 shows a high-level schematic diagram of an example embodiment of the transferor and recipient computing systems of FIG. 1;

FIG. 5 shows a simplified organization of software components stored in the example computing systems of FIG. 4;

FIG. 6 shows, in block diagram form, an example embodiment of a data store of FIG. 1;

FIG. 7 is a flowchart showing operations performed in providing a category-specific user interface for processing a request for the data transfer;

FIG. 8 is a simplified example of a credit card payment request interface;

FIG. 9 is a simplified example of a category-specific user interface including an automatic payment settings feature; and

FIG. 10 is a simplified example of a business-to-consumer payment request.

Similar reference numerals may have been used in different figures to denote similar components.

### DETAILED DESCRIPTION OF EXAMPLE EMBODIMENTS

In one embodiment, the present application describes a computer system. The computer system may include a communications module; a processor coupled to the communications module; and a memory coupled to the processor. The memory may store instructions that, when executed by the computer system, cause the computer system to: receive, via the communications module, a request for a data transfer from a transferor to a recipient, the request including one or more parameters, identify a category of the data transfer based on at least one of the one or more parameters and stored categorization data, and process the request for the data transfer based on the category by providing, to a computing device associated with the transferor, a category-specific user interface for processing the request for the data transfer.

In this way, by providing a category-specific user interface for processing a request for a data transfer, a transferor system may provide an improved user interface for processing requests for a data transfers. Conveniently, the category-specific user interface may be more intuitive than the generic user interface in an earlier system and this may improve the usability of the transferor system. Additionally or alternatively, processing the request for the data transfer in this way may be more efficient. For example, a category-specific user interface may avoid including extraneous features in the user interface. Additionally or alternatively, a category-specific user interface may provide, for example, an automatic data transfer feature that may reduce the number of times that the user interface is provided by the transferor system.

In some implementations, the one or more parameters may include a recipient identifier, the recipient identifier indicating the recipient.

In some implementations, identifying the category may comprise performing a lookup of the category based on the recipient identifier.

In some implementations, identifying the category may comprise performing a lookup of the category based on the recipient identifier.

In some implementations, the category-specific user interface may include one or more features that are not included for a category-specific user interface for another category.

In some implementations, the category-specific user interface may be configured to facilitate receiving user input including an indication of confirmation that the requested data transfer is to be made.

In some implementations, the request for the data transfer may be one of a plurality of periodic requests for respective data transfers and the one or more features may include an option for automatically processing subsequent requests in the plurality of periodic requests.

In some implementations, the one or more features may include a first feature associated with a minimum amount indicated in the request for the data transfer and a second feature associated with a full amount indicated in the request for the data transfer.

In some implementations, identifying the category may comprise, when identifying the recipient as an individual, identifying the category as a person-to-person data transfer request.

In some implementations, the category may include one or more of a periodic data transfer request, a non-periodic data transfer request, a person-to-person data transfer request, or a business-to-business data transfer request.

In some implementations, the request for the data transfer may include at least one category identifier of a defined set of category identifiers.

In another aspect, present application describes a method. The method may include receiving, via a communications module, a request for a data transfer from a transferor to a recipient, the request including one or more parameters, identifying a category of the data transfer based on at least one of the one or more parameters and stored categorization data, and processing the request for the data transfer based on the category by providing, to a computing device associated with the transferor, a category-specific user interface for processing the request for the data transfer.

In yet another aspect, present application describes a non-transitory computer-readable storage medium comprising processor-executable instructions which, when executed, configure a processor to: receive, via a communications module, a request for a data transfer from a transferor to a recipient, the request including one or more parameters; identify a category of the data transfer based on at least one of the one or more parameters and stored categorization data; and process the request for the data transfer based on the category by providing, to a computing device associated with the transferor, a category-specific user interface for processing the request for the data transfer.

In yet another aspect, the present application discloses a non-transitory, computer-readable medium storing processor-executable instructions that, when executed by one or more processors, are to cause the one or more processors to carry out at least some of the operations of a method described herein.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any subcombination, or all of the elements, without necessarily excluding any additional elements, and without necessarily requiring all of the elements.

The term “real-time,” “near real-time”, or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 ms, less than 1 second, or less than 5 seconds.

Example embodiments of the present application are not limited to any particular operating system, system architecture, mobile device architecture, server architecture, or computer programming language.

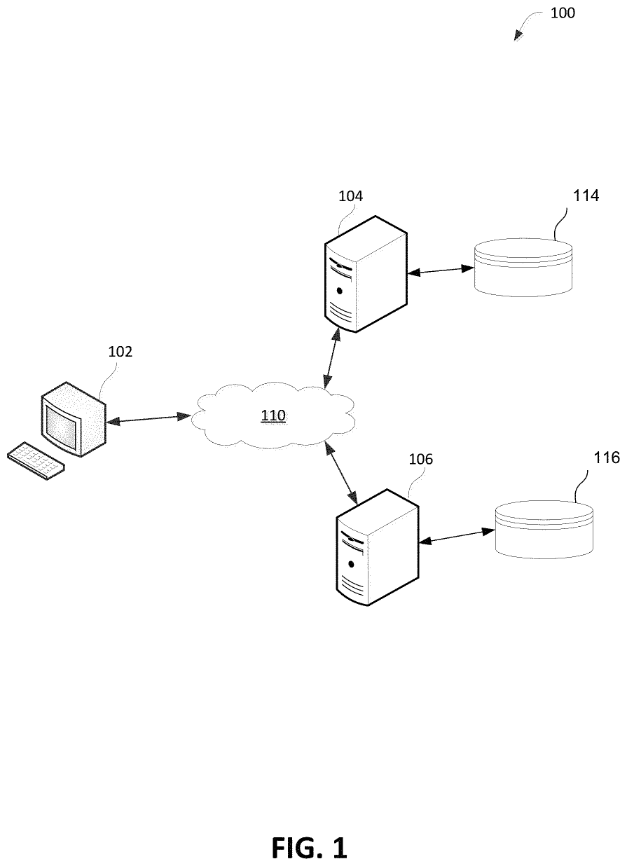

FIG. 1 shows a schematic diagram illustrating an operating environment of an example embodiment. The operating environment in this example includes a remote device 102, a transferor system 104 and a recipient system 106.

As illustrated, the transferor system 104 may provide a front-end interface which allows the remote device 102 to interact with the transferor system 104. For example, the transferor system 104 may provide one or more graphical user interfaces (GUIs) to the remote device 102. By way of example, the transferor system 104 may provide, to the remote device 102, a user interface. The user interface may be an interface for authorizing a data transfer from the transferor system 104 to the recipient system 106. That is, the user interface, when displayed on the remote device 102, provides a selectable option to indicate consent to authorization of the data transfer from the transferor system 104 to the recipient system 106 via the network 110.

The transferor system 104 may be managed, operated, or controlled by an entity that is responsible for receiving the request for a data transfer and for receiving user input from the remote device 102 for consenting to the request. The entity may be an agent of a transferor and may be a financial institution, such as a bank. The transferor may be a customer (e.g. a corporate/business customer) or client of the entity or otherwise associated with the entity.

The transferor system 104 may store data regarding one or more requests for data transfers in a plurality of respective data transfer request objects. The transferor system 104 may further store data regarding users or customers associated with the transferor system 104 in a plurality of respective user account objects representing respective user accounts.

The transferor system 104 may be used to transmit a message to a system associated with the recipient, for example, the recipient system 106. The message may transfer data indicating the requested transfer amount from a local storage area associated with the intended transferor to a local storage area associated with the recipient. The message may further include an indication to the system associated with the recipient of consent to pre-authorization of the recurring data transfer from the local storage area associated with the intended transferor to the local storage area associated with the recipient.

As illustrated, a recipient system 106 is in communication with the transferor system 104 via the network 110. The recipient system 106 may be configured to transmit to the transferor system 104 a request to configure a recurring data transfer to a recipient. The recipient system 106 may be further configured to receive a message and the recurring data transfer from the transferor system 104.

The recipient system 106 may be managed, operated, or controlled by an entity that is responsible for receiving the recurring data transfer. The entity may be an agent of the recipient and may be a financial institution, such as a bank. The recipient may be a customer (e.g. a corporate/business customer) or client of the entity or otherwise associated with the entity.

The recipient system 106 may store data regarding one or more requests for data transfers in a plurality of respective data transfer request objects. The recipient system 106 may further store data regarding users or customers associated with the recipient system 106 in a plurality of respective user account objects representing respective user accounts.

The transferor system 104 may be configured to ingest data from the recipient system 106 and may transmit alerts, notifications, configuration objects, or other data to the remote device 102 and/or the recipient system 106. More particularly, the transferor system 104 may include infrastructure that receives a request from the recipient system 106, transmits a notification to the remote device 102 and/or the recipient system 106 in response to receiving the request.

The transferor system 104 and the recipient system 106 may store data in respective data stores 114 and 116. The data stores 114 and 116 are illustrated as single units for ease of illustration, but may include a plurality of storage units and, in some cases, storage media connected via the network 110.

As illustrated, the remote device 102 is in communication with a transferor system 104 via a network 110. The remote device 102 may be managed, operated or controlled by the transferor. The remote device 102 may be associated with an alias associated with the transferor and a user account associated with the transferor and the transferor system 104. The remote device 102 may be engaged using the alias.

The remote device 102 may be used, for example, to receive user input that includes an indication of authorization of an immediate data transfer from a logical storage area associated with the intended transferor to a logical storage area associated with the recipient. The indication may further include an indication of consent to pre-authorization of a recurring data transfer from the logical storage area associated with the intended transferor and to the logical storage area associated with the recipient.

The remote device 102 is a computing device. It may, as illustrated, be a desktop computer. However, the remote device 102 may be a computing device of another type such as, for example, a smart phone, a laptop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The transferor system 104 and recipient system 106 are or include a computer system such as a computer server systems. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, web servers, email servers, file transfer protocol (FTP) servers, compute servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The remote device 102, transferor system 104 and recipient system 106 may be in geographically disparate locations.

The network 110 is a computer network. The network 110 may be an internetwork such as may be formed of one or more interconnected computer networks. For example, such a network may be or may include an Ethernet network, an asynchronous transfer mode (ATM) network, a wireless network, or the like. In some implementations, the network 110 may be the Internet. The network 110 allows the remote device 102, transferor system 104 and recipient system 106 to communicate with one another.

As further described below, the remote device 102, the transferor system 104 and recipient system 106 may be configured with software to perform associated functions such as those described herein.

FIG. 1 illustrates the transferor system 104, recipient system 106, and data stores 114 and 116 as separate computing devices. However, these systems may not be separate physical systems. For example, the transferor system 104 and the data store 114 may be implemented on a common physical device. As another example, the recipient system 106 and the data store 116 may be implemented on a common physical device. As yet another example, the transferor system 104 and recipient system 106 may be implemented in software associated with a common processor. As yet a further example, the data stores 114 and 116 may be included in the transferor system 104 and recipient system 106, respectively, or may be external to those systems.

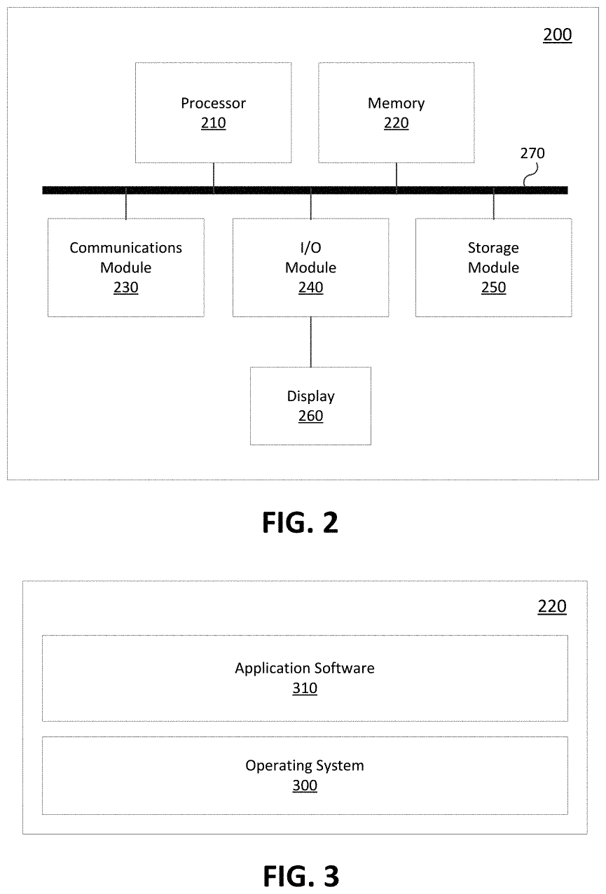

An example embodiment of the remote device 102 will now be discussed with reference to FIG. 2. FIG. 2 is a high-level schematic diagram of the remote device 100. The remote device 102 may, in some embodiments, be a personal computer as shown in FIG. 1.

The remote device 102 includes a variety of modules. For example, as illustrated, the example computing device 200 may include a processor 210, a memory 220, a communications module 230, an I/O module 240, and/or a storage module 250. As illustrated, the foregoing example modules of the example computing device 200 are in communication over a bus 270. As such, the bus 270 may be considered to couple the various modules of the remote device 102 to each other, including, for example, to the processor 210.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the remote device 102.

The communications module 230 allows the remote device 102 to communicate with other computing devices and/or various communications networks such as, for example, the network 110. For example, the communications module 230 may allow the remote device 102 to send or receive communications signals. Communications signals may be sent or received according to one or more protocols or according to one or more standards. The communications module 230 may allow the remote device 102 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G or the like. Additionally or alternatively, the communications module 230 may allow the remote device 102 to communicate using near-field communication (NFC), via Wi-Fi™, using Bluetooth™ or via some combination of one or more networks or protocols. In some embodiments, all or a portion of the communications module 230 may be integrated into a component of the remote device 102. For example, the communications module 230 may be integrated into a communications chipset.

The I/O module 240 is an input/output module. The I/O module 240 allows the remote device 102 to receive input from and/or to provide input to components of the remote device 102 such as, for example, various input modules and output modules. For example, the I/O module 240 may, as shown, allow the remote device 102 to receive input from and/or provide output to the display 260.

The storage module 250 allows data to be stored and retrieved. In some embodiments, the storage module 250 may be formed as a part of the memory 220 and/or may be used to access all or a portion of the memory 220. Additionally or alternatively, the storage module 250 may be used to store and retrieve data from persisted storage other than the persisted storage (if any) accessible via the memory 220. In some embodiments, the storage module 250 may be used to store and retrieve data in/from a database. A database may be stored in persisted storage. Additionally or alternatively, the storage module 250 may access data stored remotely such as, for example, as may be accessed using a local area network (LAN), wide area network (WAN), personal area network (PAN), and/or a storage area network (SAN). In some embodiments, the storage module 250 may access data stored remotely using the communications module 230. In some embodiments, the storage module 250 may be omitted and its function may be performed by the memory 220 and/or by the processor 210 in concert with the communications module 230 such as, for example, if data is stored remotely.

The remote device 102 may include or be connected to a display 260. The display 260 is a module of the remote device 102. The display 260 is for presenting graphics. The display 260 may be, for example, a liquid crystal display (LCD). In addition to being an output device, the display 260 may also be an input device. For example, the display 260 may allow touch input to be provided to the remote device 102. In other words, the display 260 may be a touch sensitive display module. In a particular example, the display 260 may be a capacitive touch screen.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the remote device 102. As illustrated, these software components include an operating system 300 and an application software 310.

The operating system 300 is software. The operating system 300 allows the application software 310 to access the processor 210 (FIG. 3), the memory 220, the communications module 230, the I/O module 240, and the storage module 250 of the remote device 100. The operating system 300 may be, for example, Google™ Android™, Apple™ iOS™, UNIX™, Linux™, Microsoft™ Windows™, Apple OSX™ or the like.

The application software 310 adapts the remote device 102, in combination with the operating system 300, to operate as a device for facilitating recurring data transfers.

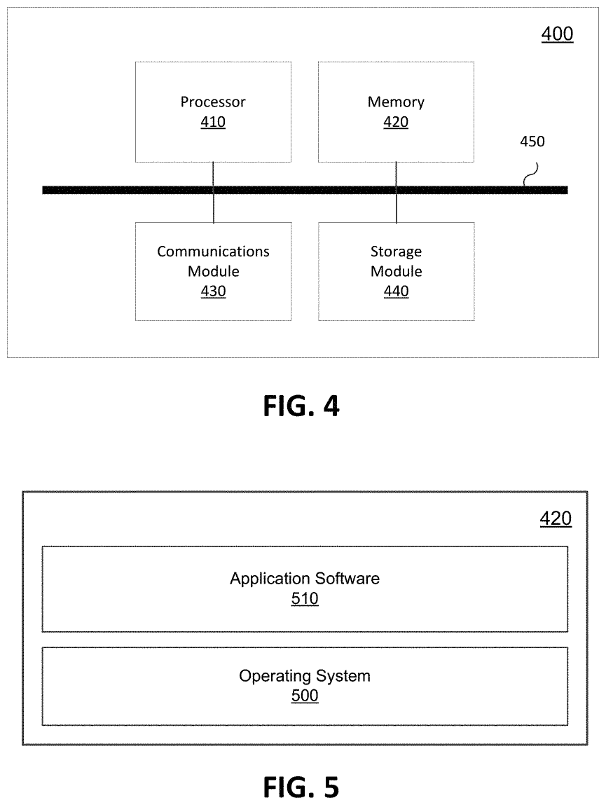

As noted above, the transferor system 104 and recipient system 106 are or include a computer system. An example computer system 400 will now be discussed with reference to FIGS. 4 and 5. Suitably-configured instances of the example computer system 400 may, in some embodiments, serve as and/or be a part of the transferor system 104 and/or recipient system 106.

FIG. 4 is a high-level schematic diagram of an example computer system 400.

The example computer system 400 includes a variety of modules. For example, as illustrated, the example computer system 400 may include a processor 410, a memory 420, a communications module 430, and/or a storage module 440. As illustrated, the foregoing example modules of the example computer system 400 are in communication over a bus 450. As such, the bus 450 may be considered to couple the various modules of the example computer system 400 to each other, including, for example, to the processor 410.

The processor 410 is a hardware processor. The processor 410 may, for example, be one or more ARM, Intel x86, PowerPC processors or the like.

The memory 420 allows data to be stored and retrieved. The memory 420 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer system 400.

The communications module 430 allows the example computer system 400 to communicate with other computing devices and/or various communications networks such as, for example, the network 110. The communications module 430 may allow the example computer system 400 to send or receive communications signals. Communications signals may be sent or received according to one or more protocols or according to one or more standards. For example, the communications module 430 may allow the example computer system 400 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G or the like. Additionally or alternatively, the communications module 430 may allow the example computer system 400 to communicate via Wi-Fi™, using Bluetooth™ or via some combination of one or more networks or protocols. In some embodiments, all or a portion of the communications module 430 may be integrated into a component of the example computer system 400. For example, the communications module may be integrated into a communications chipset.

The storage module 440 allows the example computer system 400 to store and retrieve data. In some embodiments, the storage module 440 may be formed as a part of the memory 420 and/or may be used to access all or a portion of the memory 420. Additionally or alternatively, the storage module 440 may be used to store and retrieve data from persisted storage other than the persisted storage (if any) accessible via the memory 420. In some embodiments, the storage module 440 may be used to store and retrieve data in a database. A database may be stored in persisted storage. Additionally or alternatively, the storage module 440 may access data stored remotely such as, for example, as may be accessed using a local area network (LAN), wide area network (WAN), personal area network (PAN), and/or a storage area network (SAN). In some embodiments, the storage module 440 may access data stored remotely using the communications module 430. In some embodiments, the storage module 440 may be omitted and its function may be performed by the memory 420 and/or by the processor 410 in concert with the communications module 430 such as, for example, if data is stored remotely.

Software comprising instructions is executed by the processor 410 from a computer-readable medium. For example, software may be loaded into random-access memory from persistent storage of the memory 420. Additionally or alternatively, instructions may be executed by the processor 410 directly from read-only memory of the memory 420.

FIG. 5 depicts a simplified organization of software components stored in the memory 420 of the example computer system 400. As illustrated, these software components include an operating system 500 and an application software 510.

The operating system 500 is software. The operating system 500 allows the application software 510 to access the processor 410, the memory 420, the communications module 430, and the storage module 440 of the example computer system 400. The operating system 500 may be, for example, UNIX™, Linux™, Microsoft™ Windows™, Apple OSX™ or the like.

The application software 510, when executed, co-operates with the operating system 500 to adapt the example computer system 400 for some purpose and to provide some defined functionality. For example, the application software 510 may cooperate with the operating system 500 to adapt a suitable embodiment of the example computer system 400 to serve as the transferor system 104 and/or recipient system 106.

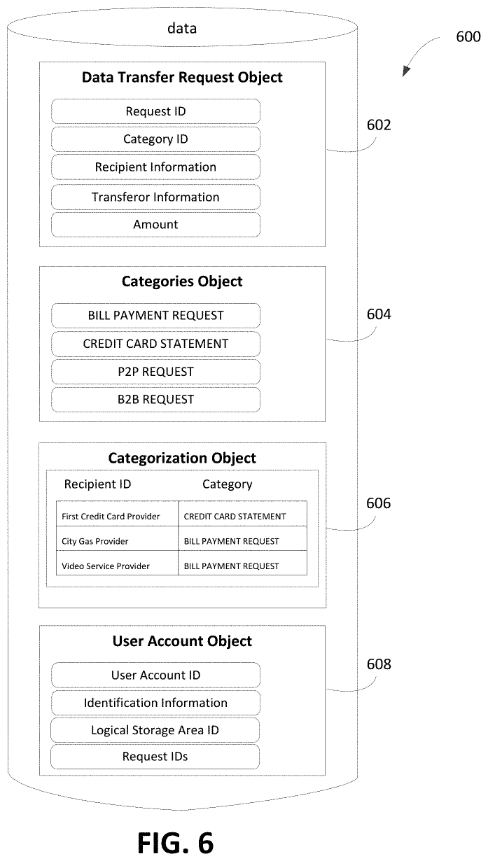

Reference is now made to FIG. 6, which partially illustrates an example data store 600 in block diagram form. The data store may be a data store 114 of the example transferor system 104 of FIG. 1 and/or a data store 116 of the example recipient system 106 of FIG. 1. Not all components of the data store 600 are illustrated. The data store 600 may include one or more data storage units. In some cases, the stored data may be in a database format and may include one or more databases. The databases may be relational databases in some examples.

The data store 600 may store data regarding a request for a data transfer in a data transfer request object 602. The data transfer request object 602 may be a data structure and may contain details or parameters regarding a request for a data transfer.

Example parameters that may be included in a request for a data transfer include:
a request identifier identifying the particular request;
a category identifier indicating the category of data transfer (e.g. bill payment, credit card payment, subscription payment, recurring bill payment);
identification information of the recipient (e.g. full name, postal address, contact details, telephone number, email address);
identification information of an intended transferor (e.g. full name, postal address, contact details, telephone number, email address, alias);
a recipient type identifier indicating the type of recipient (e.g. business, consumer, or individual);
a transferor type identifier indicating the type of transferor (e.g. business, consumer, or individual);
identification information of the recipient system and/or the entity associated with, operating or managing the recipient system (e.g. a financial institution identifier, routing number, and/or branch transit number associated with the recipient system);
identification information of the transferor system and/or the entity associated with, operating or managing the transferor system (e.g. a financial institution identifier, routing number, and/or branch transit number associated with the transferor system);
identification information of a logical storage area, for example, a logical storage area identifier (e.g. bank account number), associated with, managed or controlled by the recipient to which the requested transfer amount is to be transferred to;
identification information of a logical storage area, for example, a logical storage area identifier (e.g. bank account number), associated with, managed or controlled by the transferor from which the requested transfer amount is to be transferred from;
a requested transfer amount; or
a description of the requested transfer amount (e.g. account setup fee, enrollment or initiation fee, internet activation fee, modem purchase, utility connection fee, account transfer fee).

In some embodiments, the request for the data transfer may include parameters that may be associated with a recurring data transfer, including: an expected recurring transfer amount associated with the recurring data transfer; a description of the expected recurring transfer amount (e.g. Internet fees, phone fees, utility services, gym membership fees); and a frequency of the recurring data transfer (e.g. weekly, monthly, semi-monthly (1^{st} and 15^{th}), bi-weekly). The requested transfer amount may be the same as the expected recurring transfer amount or it may be different.

In some embodiments, the request may be a request for a data transfer of a bill payment. These and other requests may include: an invoice identifier indicating an invoice associated with the requested transfer amount; and information, associated with the invoice identifier, detailing a particular sale transaction where goods and/or services were provided to the transferor.

In some embodiments, for example, where the request is a person-to-person (P2P) transfer or an email money transfer (“EMT”) or a request to send money directly from one bank account to another, the request may include an alias of the transferor (e.g. email address or phone number) and no information identifying a financial institution associated with the transferor and/or a financial account associated with the transferor. In other words, the request may be made without including financial information associated with the transferor.

In some embodiments, for example where the request is for a credit card payment, the request may include a full requested transfer amount (e.g. a full payment) and a minimum requested transfer amount (e.g. a minimum payment).

In some embodiments, for example where the request is a business-to-business (B2B) or business-to-consumer (B2C) payment request, the request may include a due date by which the transfer must be made to avoid interest charges or other penalties.

The data store 600 may store data regarding possible categories of requests for data transfers in a categories object 604. The categories object 604 may include a plurality of defined categories that may be used by the transferor system 104 to provide a customized data transfer experience. The plurality of defined categories may include at least one of the following categories: a bill payment request; a credit card statement; a P2P data transfer request; a B2B data transfer request; a B2C data transfer request; a recurring data transfer request; a periodic data transfer request; or a non-periodic data transfer request.

In some instances, the categories may be even more granular to provide more customized payment experiences. By way of example, the category “bill payment” may be expanded into a number of different types of bill payments such as, for example, “utility payment”, “subscription service”, “e-commerce payment”, and so forth. By way of another example, the category “recurring payment” may be expanded into different types of payments that are periodic and occur on a regular schedule (e.g. daily, weekly, monthly or annually) such as, for example, “recurring bill payment” (e.g. insurance premiums, utilities), “membership payment” (e.g. gym memberships, professional memberships, golf club memberships) and “subscription payment” (e.g. video or music streaming services, meal kit delivery, lifestyle boxes).

The data store 600 may further store data for categorizing requests for data transfers in a categorization object 606. In some embodiments, the categorization object may include a plurality of mapping definitions in a lookup table. A mapping definition may be defined for specifying a mapping of a parameter of a request for a data transfer to a data transfer category included in the categories object 604. For example, a lookup table may, in at least some embodiments, be used to map a recipient identifier to one or more categories. By way of example, a lookup table may include associations such as: “First Credit Card Provider” is a “credit card statement”; “City Gas Provider” is a “bill payment request”; “Video Service Provider” is a “bill payment request” and “First Business” is a “B2C payment request”. By way of another example, if more granular categories are provided, the lookup table may include associations such as “City Gas Provider” is a “utility payment” and “Video Service Provider” is a “subscription service”.

The data store 600 may further store data regarding a user or customer associated with an associated system, for example, transferor system 104 or recipient system 106, in a user account object 608 representing a user account. A user account object 608 may be a data structure and may include details regarding a user. Example details include a user account identifier indicating a particular user, identification information (e.g. first and last name), an alias (e.g. email address, phone number), contact information (e.g. home address), sign in or authentication credentials (e.g. user name, password), and one or more request identifiers that may link to one or more data transfer request objects.

A user account may be associated with a logical storage area. A logical storage area be or include an area of the data store 600. A logical storage area may further be or represent a bank account. In some embodiments, the data store 600 may include a database of customer accounts and bank accounts at a particular financial institution.

A user account object 608 may include one or more identifiers that may link to one or more respective logical storage areas. For example, a user account object 608 may include a logical storage area identifier indicating a logical storage area that is associated with a user, for example, a transferor or a recipient.

The transferor system 104 illustrated in FIG. 1 may store one or more data transfer request objects 602, categories objects 604, categorization objects 606, and user account objects 608 in a data store 114.

The recipient system 106 illustrated in FIG. 1 may also store one or more data transfer request objects 602, categories objects 604, categorization objects 606, and user account objects 608 in a data store 116.

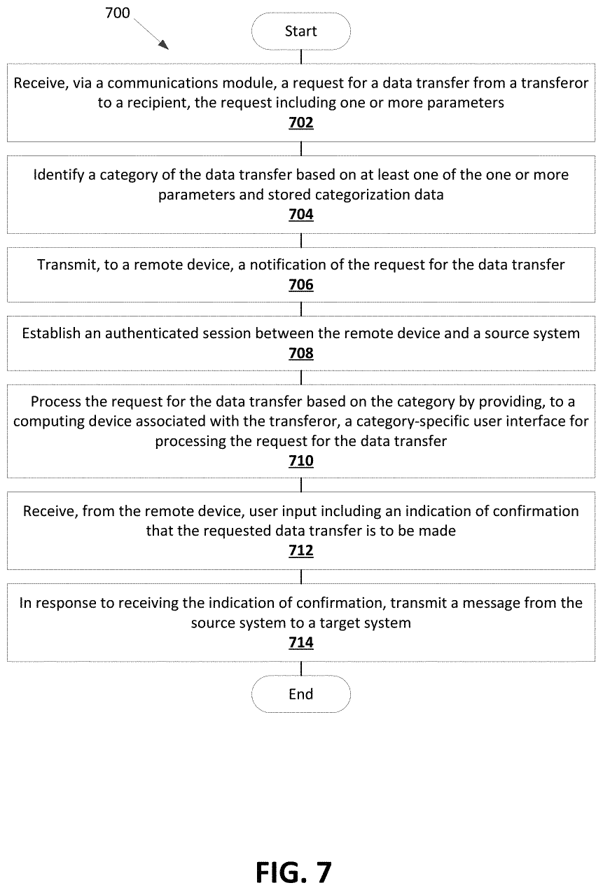

Reference will now be made to FIG. 7 which illustrates an example method 700. The operations of method 700 may be performed by a transferor system 104 which may be of the type described herein.

In operation 702, the transferor system may receive, via a communications module, a request for a data transfer from a transferor to a recipient, the request including one or more parameters. In some embodiments, the request for the data transfer is received from a recipient system and is implemented as an ISO 20022 Request for Payment Message. When a request for a data transfer is received by the transferor system, the transferor system may store the request in the example data transfer request object 602 of FIG. 6.

In operation 704, upon receiving the request transmitted by the recipient system, the transferor system may identify a category of the data transfer based on at least one of the one or more parameters and stored categorization data. The stored categorization data may include, for example, data stored in the example categories object 604 and categorization object 606 of FIG. 6.

By way of example, when the request for the data transfer is received, the contents of the request for the data transfer may be analyzed to determine a category or type associated with the request for the data transfer. The category or type may be, for example, one or more of the following categories: bill payment request; credit card statement; P2P payment request; B2B payment request; or B2C payment request.

The one or more parameters included in the request may be used to determine the category or type. For example, the request for the data transfer may include a category identifier or type identifier representing a category or type of the data transfer. By way of example, the request for the data transfer may include a category identifier that specifies a “B2B payment request” category. The category identifier may be a category specified in a standard set of possible category identifiers. In some embodiments, the set of possible category identifiers may be defined according to the example categories object 604 described in FIG. 6.

In some embodiments, the request for the data transfer may include a recipient identifier and the recipient identifier may be used in the identification of a category or type. By way of example, a lookup table may, in at least some instances be used to map recipient identifiers to categories or types. An example of a lookup table is the table shown in the categorization object 606 of FIG. 7. In this example, if the recipient identifier is “First Credit Provider”, the transferor system may use the lookup table to determine that the request for the data transfer is a credit card statement.

In some embodiments, the category may be determined based on the recipient identifier and/or the transferor identifier. When both the recipient identifier and the transferor identifier identify respective businesses, then the transferor system may determine that the category is a B2B payment request. When both the recipient identifier and the transferor identifier identify respective individuals, then the transferor system may determine that the category is a P2P payment request. In some embodiments, when the recipient identifier identifies an individual, then the transferor system may determine that the category is a P2P request. In particular, the payment request may be identified as a P2P payment request based on the recipient identifier and without the use of the transferor identifier.

In some embodiments, the request for the data transfer may include a recipient type parameter and a transferor type parameter that may be used in the identification of a category or type. For example, when the recipient type indicates that the recipient of the data transfer is a business and the transferor type parameter indicates that the transferor is a consumer, the transferor system may determine that the category is a B2C payment request. As another example, when the recipient type indicates that the recipient of the data transfer is a business and the transferor type parameter indicates that the transferor is a business, the transferor system may determine that the category is a B2B payment request. As another example, when the recipient type indicates that the recipient of the data transfer is an individual and the transferor type parameter indicates that the transferor is an individual, the transferor system may determine that the category is a P2P payment request.

In some embodiments, the identification of a category or type may be based on the recipient type. In some embodiments, the request for the data transfer may include a recipient type without including a transferor type, and the recipient type may be used or analyzed to determine a category that is not based on an analysis of a transferor type. For example, when the recipient type indicates that the recipient of the data transfer is an individual, the transferor system may determine that the category is a P2P request or that the category is a request from an individual.

In operation 706, the transferor system may transmit, to a remote device, a notification of the request for the data transfer. The remote device may be associated with the transferor indicated in the request for the data transfer. In particular, the remote device may be associated with a transferor alias (e.g. email address or phone number) included in the request for the data transfer. Transmitting the notification may involve using the alias to transmit a notification to the remote device, which may be associated with the alias. In some embodiments, the notification may be an email or text message.

The notification may include an indication of the request, the identified category, a request identifier, a recipient identifier, a requested transfer amount, or one or more of the parameters included in the request for the data transfer.

The remote device may present the notification to a user of the remote device via a user interface. The user interface may be that of a messaging application, such as an email application, text and/or voice message application, instant message application, or an application relating to a transferor identifier included in the request for the data transfer, an application relating to the transferor system, or an application for providing alerts. In some embodiments, the user interface may be a graphical user interface that presents the notification via pop-up, alert, or in any other suitable manner.

The notification may be actionable, such as through a selectable link or other actionable user interface element, to either directly indicate a user selection or to navigate to a website, webpage, application interface, or other user interface through which the user is prompted to indicate a user selection.

In some embodiments, the notification includes a selectable option to navigate to a website or a webpage, hosted on the transferor system. The selectable option may be associated with a uniform resource identifier (URI) that links to a resource associated with the transferor system. In some embodiments, the selectable option may be a link for launching a user interface provided by the transferor system. By way of example, the link may be invoked to launch an authentication user interface for accepting user authentication at the transferor system. When invoked, the link may also pass to the selected transferor system the request identifier. By way of another example, the link may be invoked to launch a category-specific user interface for processing the request for the data transfer. In some examples, in response to receiving a request that is sent to the transferor system upon invoking the link, the transferor system may determine that it is operating an unauthenticated session with the remote device. In response to determining that the transferor system is operating an unauthenticated session, the transferor system can display an authentication interface for accepting user authentication prior to displaying the category-specific user interface.

In operation 708, the transferor system may establish an authenticated session with the remote device. An authenticated session may include a session in which the identity of the user is verified by the transferor system through receiving and authenticating user account credentials. The user account credentials may include a user name and password combination, biometric information, or other credential data. In some embodiments, establishing an authenticated session may involve the transferor system providing to the remote device an authentication interface that prompts the user to sign in to the transferor system with credentials. The transferor system may receive credentials via the authentication user interface to establish an authenticated session with the remote device. In some embodiments, the remote device may authenticate itself as being associated with a user account that is associated with the transferor and the transferor system by providing a credential to the transferor system via an authentication interface launched through the notification interface.

In operation 710, the transferor system may process the request for the data transfer based on the identified category by providing, to the remote device associated with the transferor, a category-specific user interface for processing the request for the data transfer. For example, when the category is identified as a credit card payment, the transferor system may provide a credit card payment user interface that is used only for credit card payments.

In operation 712, the transferor system receives, from the remote device, user input including an indication of confirmation that the requested data transfer is to be made. The user input may be received via an actuation of a selectable menu item, icon, or other graphical element included in the category-specific user interface. Put another way, the transferor system receives a data transfer instruction instructing the transferor system to transmit a message to a system associated with the recipient, for example, the recipient system. The message may include transfer data indicating a transfer amount from a logical storage area associated with the intended transferor to a logical storage area associated with the recipient.

The user input may further include an indication of one or more selections made with respect to one or more features or elements of the category-specific interface. The message that is transmitted from the transferor system to the recipient system may be based on the one or more selections. By way of example, the user input may indicate the timing of the data transfer. For example, the user input may indicate that the message should be transmitted immediately in response to receiving the data transfer instruction or at a later date or time.

In some embodiments, the user input may further include an indication of consent to pre-authorization of a recurring data transfer from a local storage area associated with the intended transferor to the logical storage area associated with the recipient.

In operation 714, in response to receiving the indication of confirmation, the transferor system may transmit the message including the transfer data to the recipient system.

Examples of category-specific user interfaces will now be described.

A category-specific user interface may be used process requests for data transfers that correspond to the same category as the category-specific user interface. For example, a P2P user interface may be used to process a P2P request for a data transfer, and a separate and distinct B2C user interface may be used to process a B2C request for a data transfer. A category-specific user interface have certain features that are not included in a user interface that is used to process other requests for data transfers. By way of example, a credit card payment request user interface can include a minimum payment feature, while none of the other user interfaces that are used to process the other categories of requests for data transfers may include a minimum payment feature. In some cases, some of the category-specific user interfaces include the same feature, such as an account feature that offers selection of a logical storage area associated with the transferor.

A category-specific interface may include one or more features. A feature may be pre-populated with data or parameters included in the request for the data transfer. A feature may also solicit input and facilitate one or more selections from one or more options. In some cases, a feature may require active selection of an option, field, or setting. A feature may be implemented using one or more user interface elements, including menus, buttons, icons, radio buttons or option buttons, checkboxes, or other selectable graphical elements for initiating various operations in connection with the data transfer. A feature may include text boxes or other graphical elements for receiving input of text information, including numbers, for example, an amount of money, for use in various operations in connection with the data transfer. A feature may also include text, labels, images or other graphical elements for displaying information in the user interface.

In at least some embodiments, a user interface element may be invoked, actuated or otherwise selected by a user. Selection of a user interface element can include conventional user input operation on the user interface element so as to provide a signal or instruction to a browser application or other executing application that a selection of the user interface element has been made by the user and/or that a particular action represented by the user interface element is to be carried out. Different forms of selection, for example, by a touch, gesture, pointing device, or voice command, will be known to those skilled in the art. In some cases, a command, action, or operation associated with the user interface element can be invoked as a result of user input selecting or otherwise acting on a user interface element.

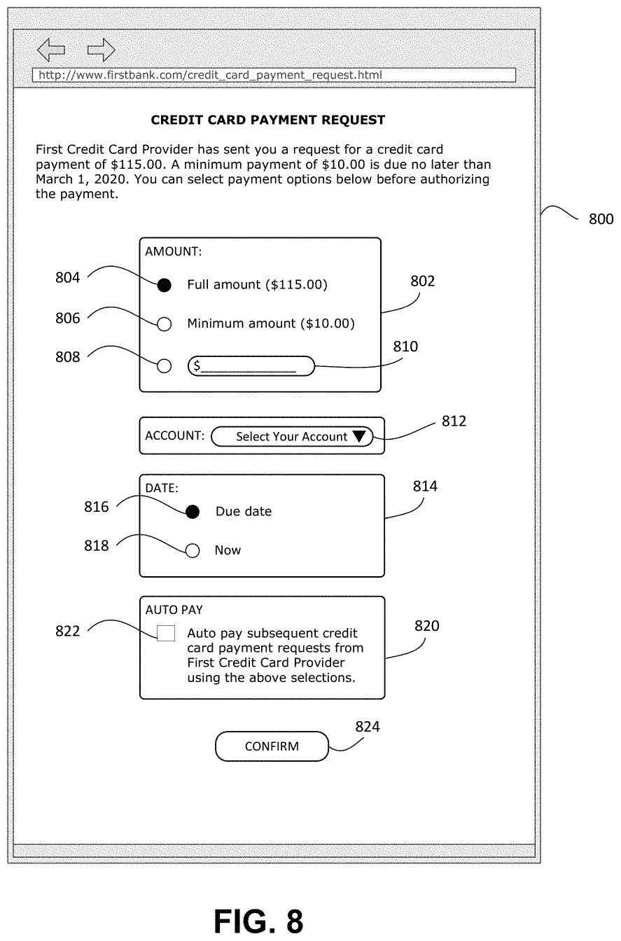

Reference will now be made to FIG. 8 which illustrates an example of a credit card payment request interface 800. The credit card payment request interface may be provided, by the transferor system to the remote device, in response to a request for a data transfer that is categorized as a credit card payment. The credit card payment request interface 800 is sometimes referred to as a category-specific user interface.

The credit card payment request interface 800 prompts the user to provide their consent for the data transfer and displays user selectable options for the data transfer.

The example credit card payment request interface 800 includes an “amount” feature for receiving user input indicating an amount to be transferred. The amount feature includes an amount element 802 that provides user selectable options for indicating the actual transfer amount. In some embodiments, a list of requested transfer amounts may be provided for selection as well as the possibility of specifying a different amount with additional input. The list of requested transfer amounts may include a full requested transfer amount and a minimum requested transfer amount, either of which may be preselected by the transferor system as a default amount.

The amount feature may include a “full amount due” feature for paying in full, a “minimum amount due” feature for paying a minimum amount, and a “user defined amount” feature for paying a portion of the full amount.

As illustrated, the “full amount due” feature includes a full amount element 804 that offers selection of a full requested transfer amount specified in the request for the data transfer. The “minimum amount due” feature includes a minimum amount element 806 that offers selection of the minimum requested transfer amount specified in the request for the data transfer. The “user defined amount” feature includes a custom amount element 808 that offers selection of a user defined amount and an amount element 810 that provides an input area to receive data indicating the amount to be transferred. The user defined input amount may be less than or greater than the minimum requested amount and/or the full requested amount.

As illustrated, the full amount element 804 is preselected. In this example, the full amount element 804, minimum amount element 806 and custom amount element 808 are mutually exclusive options. When a user selects one of these options, any previously selected option is deselected.

The example credit card payment request interface 800 includes a “logical storage area” or “account” feature for receiving user input indicating a logical storage area identifier associated with the intended transferor, in this example a bank account associated with the user, from which the indicated amount is to be transferred from. In other words, the account feature may prompt a user to select a logical storage area from which to make the data transfer. As illustrated, the account feature may include a drop-down list element 812 that displays the available logical storage areas from which the selected amount may be transferred. The available logical storage areas may include logical storage areas associated with the authenticated user. In some embodiments, the transferor system may use a default logical storage area identifier to preselect the default logical storage area in the credit card payment request interface 800.

The example credit card payment request interface 800 includes a “date” feature for receiving user input indicating selection of a date on which the transfer is to be made. As illustrated, the date feature includes a date element 814 that provide user selectable options for indicating the date. In some embodiments, a date may be provided for selection as well as the possibility of specifying a different date with additional input. The date may be or correspond to a date parameter included in the request for the data transfer.

The date feature may provide a list of dates for selection, including a “requested date” feature and an “immediate data transfer” feature. As illustrated, the “requested date” feature may be a “due date” feature that includes a due date element 816 that offers selection of a due date specified in the request for the data transfer. The due date may be a deadline for making the data transfer without incurring penalties imposed by the recipient, such as, for example, interest charges on a requested transfer amount. The “immediate data transfer” feature includes a now element 818 that offers selection of the current date in order to initiate an immediate data transfer. Those skilled in the art will recognize that other features may be provided for receiving input indicating the selection of a date, such as a calendar feature that provides an input area to receive selection of a date.

The example credit card payment request interface 800 includes an automatic data transfer feature for receiving user input indicating authorization to initiate an automatic data transfer to a recipient in response a recurring request for the data transfer from the recipient. In other words, the automatic data transfer feature offers selection of an indication of consent to pre-authorize a recurring data transfer. Put another way, the request for the data transfer may be the first request in a sequence of requests for respective data transfers and the automatic data transfer feature may include an interface element for indicating consent to pre-authorize future requests in the sequence of requests for respective data transfers.

In some embodiments, the request for the data transfer is one of a plurality of requests for respective data transfers and the automatic data transfer feature includes an option for automatically processing future requests in the plurality of requests. The plurality of requests may be a plurality of recurring or periodic requests. The corresponding data transfers may be transmitted using one or more of the selected features.

In some embodiments, the transferor system identifies a same category for each data transfer in the plurality of requests for respective data transfers. That is, a category that is identified for the current request for the data transfer may be the same category that is identified for the future request for the data transfer. For example, the current data transfer may be identified as a credit card payment and the future data transfer that is to be automatically paid may also be identified as a credit card payment. In this way, future credit card payments from the transferor to the recipient may be automatically paid, while other categories or types of data transfers from the transferor to the recipient may not be automatic.

As illustrated, the automatic payment feature includes an automatic payment element 820 for configuring an automatic data transfer. The automatic payment element 820 includes a selectable option 822 for indicating authorization to automatically transfer data to the recipient. The option may be presented as a checkbox or other selectable user interface element and may include text. By way of example, the text for the option may read “Automatically pay future credit card payment requests from the recipient using the selected amount, account and date”. In some embodiments, the request for the data transfer may include a credit card identifier, which may include a credit card provider name, a credit card number and/or a type of the credit card, and the text may reflect that automatic payments should be made only for requests for data transfers that include that credit card identifier. By way of example, the text may read “Automatically pay future credit card statements for credit card number 0123 4567 8910.”

The remote device transmits to the transferor system a data transfer instruction with respect to the request for the data transfer. The instruction is received by the transferor system via the credit card payment request interface 800, through the selection of a confirmation element 824. The received instruction may further include receipt of additional details, such as the selection and configuration of one or more options or features, including the transfer amount, the transferor's account, the timing of the data transfer, and the auto pay setting. The instruction and additional details may be stored on the transferor system. When the data transfer instruction is received by the transferor system, the transferor system transmits a message including transfer data to the recipient system. The message is transmitted according to the date specified in the date feature.

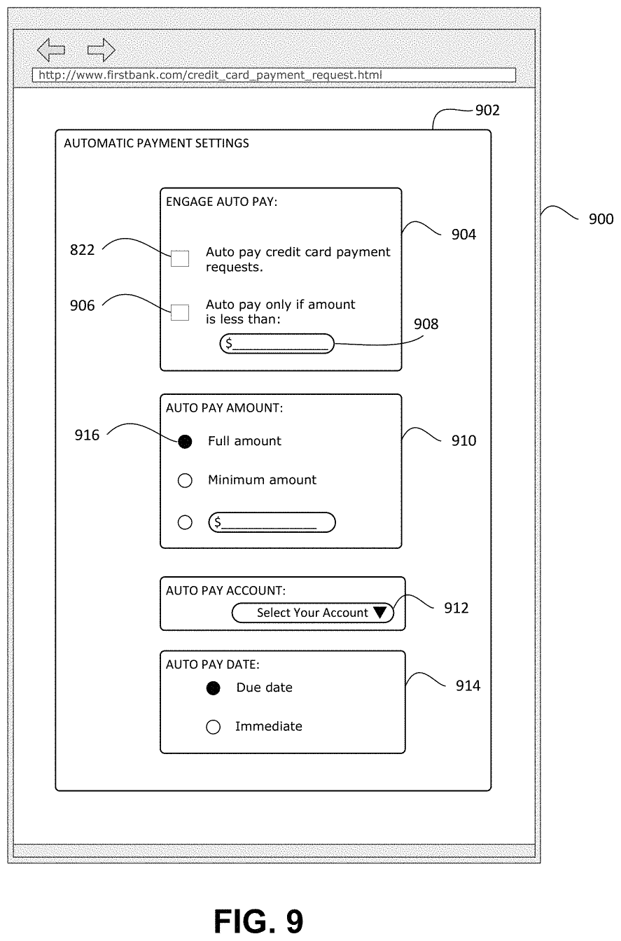

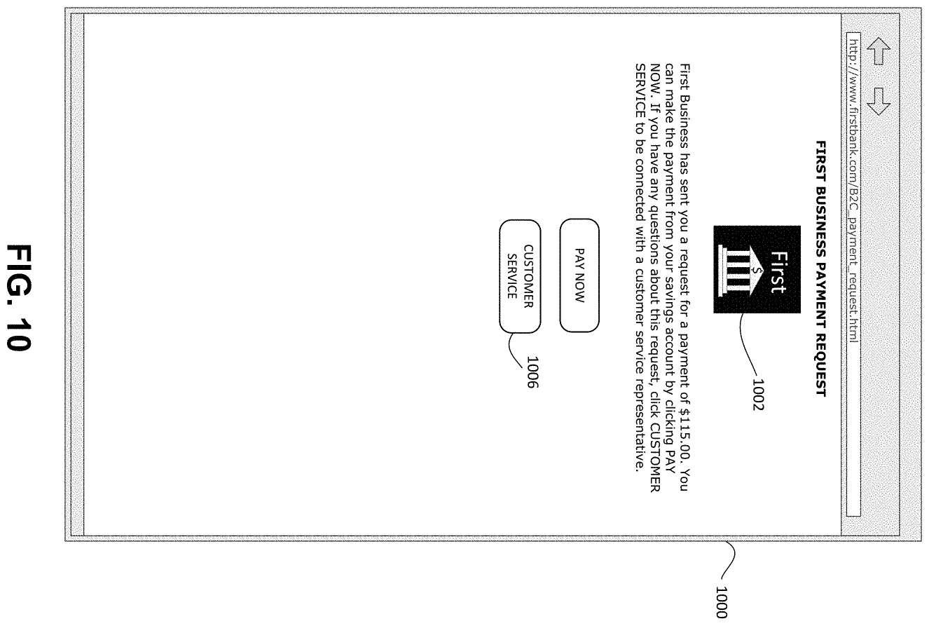

Reference will now be made to FIG. 9 which illustrates an example automatic payment settings feature according to an embodiment of a credit card payment request interface 900. The automatic payment settings feature may facilitate the enablement and configuration of automatic processing of requests for data transfers.

Although not shown in FIG. 9, the credit card payment request interface 900 may include one or more features and corresponding user interface elements 802, 812 and 814 and/or a confirmation element 824 as shown in FIG. 8 and an automatic payment settings feature including the automatic payment settings element 902. Put another way, the credit card payment request interface 900 may be a modified version of the credit card payment request interface 800 of FIG. 8 in which the modification includes including the automatic payment settings element 902 of FIG. 9 instead of the automatic payment element 820 of FIG. 8.

The automatic payment settings feature includes an “engage automatic payment” feature for receiving user input indicating selection of an option for automatically transferring a credit card payment in response to receiving a request for a credit card payment. As illustrated, the engage automatic payment feature includes an engage automatic payment element 904 that offers selection of options for enabling the automatic data transfers. In this way, certain categories of requests for payments may be automatically paid as long as user defined criteria is satisfied.

The engage automatic payment feature may include a list of options for selection, including an “auto pay all” feature and an “auto pay threshold” feature. As illustrated, the “auto pay all” feature includes the selectable option 822 of FIG. 8. The “auto pay threshold” feature includes a selectable option 906 and a threshold amount element 908 that provides an input area to receive data indicating a threshold amount. The selectable option 906 offers a selection indicating that the automatic payment should be made only if the transfer amount is less than the threshold amount.

The engage automatic payment feature may include an automatic payment amount feature including an automatic payment amount element 910, an automatic payment account feature including an automatic payment account element 912, and an automatic payment date feature including an automatic payment date element 914. These features may provide similar functionality as the amount, account and date features of FIG. 8 and may allow users to select different amounts, accounts and dates to be used for the automatic payments than those that are used for the payment corresponding to the received request for the credit card payment. For instance, the user may select the minimum amount element 806 of FIG. 8 to transfer a minimum payment in response to the current request for the credit card payment, but may also select the selectable option 906 and a full amount element 916 of FIG. 9 to automatically transfer a full payment in response to a future request for a credit card payment so long as the full amount is less than a user defined threshold amount.

A credit card payment request user interface can include features that are not included in a user interface that is used to process other requests for data transfers. By way of example, a credit card payment request user interface can include a full amount feature and a minimum amount feature, while none of the other user interfaces that are used to process the other categories of requests for data transfers may include these features.

In some embodiments, feature may be included in some but not all category-specific user interfaces. For example, an automatic payment feature may be included in a credit card payment request user interface, subscription payment request user interface and/or a recurring payment request user interface, but may not be included in a P2P payment request user interface.

Another category-specific user interface is shown in FIG. 10, which illustrates an example of a B2C payment request interface 1000. The B2C payment request interface 1000 may be provided, by the transferor system to the remote device, in response to a request for a data transfer that is identified and categorized as a B2C payment.

In some embodiments, a category-specific user interface may have certain features that are not included in the user interface that is used to process other requests for data transfers. For example, a category-specific user interface may include a feature that causes an application or graphical user interface element associated with or provided by the recipient to appear. By way of example, the B2C payment request interface 1000 may include a customer service feature that includes a selectable option 1006 causing the launch of a chat application, a phone call application, or user interface element, such as a live chat window, connecting a user to a customer service representative associated with the recipient for assisting customers. The selectable option 1006 may be a link associated with a URI that links to a resource associated with the transferor system, the recipient system or a third-party system. The URI may be a parameter in the request for the data transfer.

In some embodiments, a category-specific user interface may include a feature causing an image associated with the recipient to appear. For example, the request for the data transfer may include a parameter indicating image data to be displayed in the user interface. The parameter may include data representing the image or may include a URI that links to an image file located on a computing system that is operated, managed or associated with the recipient. Alternatively or additionally, the transferor system may have a library of images that are associated with recipient identifiers. An image may be retrieved from the library based on the recipient identifier. The image may, for example, include a logo, branding or data associated with the recipient that facilitates the recognition of the recipient of the data transfer by the user. By way of example, the B2C payment request interface 1000 may include a recipient branding feature that includes an image element 1002 representing a logo of the recipient. The image element may be, for example, a link to a website operated by the recipient. As another example, the image feature may be an advertisement feature cause an image including an advertisement provided by the recipient to appear.

In some embodiments, the chat or customer service feature, recipient branding feature, or recipient advertisement feature may be provided if, for example, the request for the data transfer was determined to be a B2B or B2C payment request and may not be provided if, for example, the request for the data transfer was determined to be a P2P or other category of request.

Another example of a category-specific user interface is a subscription payment user interface. A subscription payment user interface may include, for example, an automatic payment settings feature for automatically transferring a payment in response to a future request for a recurring payment. In other words, the subscription payment user interface may include an option to automatically pay subsequent bills such that subsequent bills (i.e. at a next billing interval) are automatically paid without the transferor system receiving further user input after receiving the future request for the subscription payment. Such an automatic payment settings feature may not be provided if, for example, the request for the subscription payment was determined to be a P2P request.

Since subscriptions often require full payment before the subscribed to service is performed, the subscription payment user interface not provide the option of selecting a transfer amount either for the currently received request for the data transfer or for future requests for data transfers. As such, the automatic payment settings feature may be implemented using the automatic payment settings feature of FIG. 9, but without the automatic payment amount feature of FIG. 9. Alternatively, the subscription payment may be performed using the requested transfer amount specified in the request for the data transfer.

It will be appreciated that it may be that some or all of the above-described features of the various above-described example category-specific user interfaces may be included in one or more category-specific user interfaces in combinations other than those illustrated.

It will be further appreciated that it may be that some or all of the above-described operations of the various above-described example methods may be performed in orders other than those illustrated and/or may be performed concurrently without varying the overall operation of those methods.

Although many of the above examples refer to an “object” when discussing a data structure, it will be appreciated that this does not necessarily restrict the present application to implementation using object-oriented programming languages, and does not necessarily imply that the data structure is of a particular type or format. Data structures may have different names in different software paradigms.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A computer system comprising:
a communications module;
a processor coupled to the communications module; and
a memory coupled to the processor storing instructions that, when executed by the computer system, cause the computer system to:
receive, via the communications module, a request for a data transfer from a transferor to a recipient, the request including one or more parameters;
identify a category of the data transfer based on at least one of the one or more parameters and stored categorization data; and
process the request for the data transfer based on the category by providing, to a computing device associated with the transferor, a category-specific user interface for processing the request for the data transfer.

2. The computer system of claim 1, wherein the one or more parameters include a recipient identifier, the recipient identifier indicating the recipient.

3. The computer system of claim 2, wherein identifying the category comprises performing a lookup of the category based on the recipient identifier.

4. The computer system of claim 1, wherein the category-specific user interface includes one or more features that are not included for a category-specific user interface for another category.

5. The computer system of claim 4, wherein the category-specific user interface is configured to facilitate receiving user input including an indication of confirmation that the requested data transfer is to be made.

6. The computer system of claim 4, wherein the request for the data transfer is one of a plurality of periodic requests for respective data transfers and the one or more features include an option for automatically processing subsequent requests in the plurality of periodic requests.

7. The computer system of claim 4, wherein the one or more features include a first feature associated with a minimum amount indicated in the request for the data transfer and a second feature associated with a full amount indicated in the request for the data transfer.

8. The computer system of claim 1, wherein identifying the category comprises, when identifying the recipient as an individual, identifying the category as a person-to-person data transfer request.

9. The computer system of claim 1, wherein the category includes one or more of a periodic data transfer request, a non-periodic data transfer request, a person-to-person data transfer request, or a business-to-business data transfer request.

10. The computer system of claim 1, wherein the request for the data transfer includes at least one category identifier of a defined set of category identifiers.

11. A method comprising:
receiving, via a communications module, a request for a data transfer from a transferor to a recipient, the request including one or more parameters;
identifying a category of the data transfer based on at least one of the one or more parameters and stored categorization data; and
processing the request for the data transfer based on the category by providing, to a computing device associated with the transferor, a category-specific user interface for processing the request for the data transfer.

12. The method claim 11, wherein the one or more parameters include a recipient identifier, the recipient identifier indicating the recipient.

13. The method of claim 12, wherein identifying the category comprises performing a lookup of the category based on the recipient identifier.

14. The method of claim 11, wherein the category-specific user interface includes one or more features that are not included for a category-specific user interface for another category.

15. The method of claim 14, wherein the category-specific user interface is configured to facilitate receiving user input including an indication of confirmation that the requested data transfer is to be made.

16. The method of claim 14, wherein the request for the data transfer is one of a plurality of periodic requests for respective data transfers and the one or more features include an option for automatically processing subsequent requests in the plurality of periodic requests.

17. The method of claim 14, wherein the one or more features include a first feature associated with a minimum amount indicated in the request for the data transfer and a second feature associated with a full amount indicated in the request for the data transfer.

18. The method of claim 11, wherein identifying the category comprises, when identifying the recipient as an individual, identifying the category as a person-to-person data transfer request.

19. The method of claim 11, wherein the category includes one or more of a periodic data transfer request, a non-periodic data transfer request, a person-to-person data transfer request, or a business-to-business data transfer request.

20. A non-transitory computer-readable storage medium comprising processor-executable instructions which, when executed, configure a processor to:
receive, via a communications module, a request for a data transfer from a transferor to a recipient, the request including one or more parameters;
identify a category of the data transfer based on at least one of the one or more parameters and stored categorization data; and
process the request for the data transfer based on the category by providing, to a computing device associated with the transferor, a category-specific user interface for processing the request for the data transfer.
